(19) United States
(12) Patent Application Publication
(10) Pub. No.: US 2023/0012622 A1
(43) Pub. Date: Jan. 19, 2023

(54) REPRODUCTION CONTROL METHOD, REPRODUCTION CONTROL SYSTEM, AND PROGRAM

(71) Applicant: Yamaha Corporation, Hamamatsu (JP)

(72) Inventor: Tatsuya IRIYAMA, Hamamatsu (JP)

(21) Appl. No.: 17/950,697

(22) Filed: Sep. 22, 2022

Related U.S. Application Data
(63) Continuation of application No. PCT/JP2020/045816, filed on Dec. 9, 2020.

(30) Foreign Application Priority Data
Mar. 23, 2020 (JP) 2020-050817

(51) Int. Cl. G10H 1/00; G10H 1/34; G10H 1/36

(52) U.S. Cl. CPC G10H 1/0008; G10H 1/34; G10H 1/366

(57) ABSTRACT

A reproduction control method, which is executed by a computer, includes detecting a first state in which an object is separated from an operation surface by a prescribed distance and a second state in which the object is in contact with the operation surface, initiating sound reproduction at a first time point at which the first state is detected, continuing the sound reproduction from the first time point to a third time point which is subsequent to a second time point at which the second state is detected, and controlling a change in a feature amount of a sound during a first time period from the first time point to the second time point.

### CROSS-REFERENCE TO RELATED APPLICATIONS

This application is a continuation application of International Application No. PCT/JP2020/045816, filed Dec. 9, 2020, which claims priority to Japanese Patent Application No. 2020-050817 filed in Japan on Mar. 23, 2020. The entire disclosures of International Application No. PCT/JP2020/045816 and Japanese Patent Application No. 2020-050817 are hereby incorporated herein by reference.

### BACKGROUND

### Technological Field

The present disclosure relates to a technology for controlling sound.

### Background Information

Various technologies for changing a feature amount of a sound reproduced in accordance with a user instruction, for example, have been proposed in the prior art. For example, Japanese Laid-Open Patent Application No. 2017-161699 discloses an electronic musical instrument in which the pitch of a sound that is reproduced in response to a key depression by the user is changed (pitch bend) in response to a user operation of a pitch bend wheel.

### SUMMARY

However, in the conventional configuration, the pitch bend instruction by a user operation of the pitch bend wheel must be made separately from the instruction to generate sound by depressing a key. Therefore, there is the problem that the operations that are required to reproduce the desired sound are highly burdensome to the user. Given this circumstance, an object of one aspect of the present disclosure is to reduce the burden of the user instructions required for sound reproduction.

A reproduction control method according to one aspect of the present disclosure is executed by a computer and comprises detecting a first state in which an object is separated from an operation surface by a prescribed distance and a second state in which the object is in contact with the operation surface, initiating sound reproduction at a first time point at which the first state is detected, continuing the sound reproduction from the first time point to a third time point which subsequent to a second time point at which the second state is detected, and controlling a change in the feature amount of a sound during a first time period, i.e., from the first time point to the second time point.

A reproduction control method according to one aspect of the present disclosure is executed by a computer and comprises reproducing a sound in a state in which an object is in contact with an operation surface, and changing a feature amount of the sound at a speed that corresponds to a movement speed with which the object is moving in a process of the object separating from the operation surface.

A reproduction control system according to one aspect of the present disclosure comprises an electronic controller including at least one processor. The electronic controller is configured to execute a plurality of modules including a state detection module and a reproduction control module. The state detection module is configured to detect a first state in which an object is separated from an operation surface by a prescribed distance and a second state in which the object is in contact with the operation surface. The reproduction control module is configured to initiate sound reproduction at a first time point at which the first state is detected, continue the sound reproduction from the first time point to a third time point, which is subsequent to a second time point at which the second state is detected, and control a change in a feature amount of a sound during a first time period from the first time point to the second time point.

A non-transitory computer readable medium storing a program according to one aspect of the present disclosure causes a computer to execute a process, and the process comprises detecting a first state in which an object is separated from an operation surface by a prescribed distance and a second state in which the object is in contact with the operation surface, initiating sound reproduction at a first time point at which the first state is detected, continuing the sound reproduction from the first time point to a third time point, which is subsequent to a second time point at which the second state is detected, and controlling a change in the feature amount of the sound during a first time period, i.e., from the first time point to the second time point.

### BRIEF DESCRIPTION OF THE DRAWINGS

FIG. 1 is a block diagram illustrating the configuration of a reproduction control system.

FIG. 2 is a schematic diagram illustrating the configuration of a detection unit.

FIG. 3 is a block diagram illustrating the functional configuration of a control system.

FIG. 4 is an explanatory diagram pertaining to the state of a user's hand.

FIG. 5 is a flowchart illustrating the specific procedure of a control process.

FIG. 6 is an explanatory diagram pertaining to the state of a hand in a third embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

FIG. 1 is a block diagram illustrating the configuration of a reproduction control system 100 according to a first embodiment of the present disclosure. The reproduction control system 100 is a computer system that reproduces a sound (hereinafter referred to as “target sound”) in response to a user operation. The reproduction control system 100 has a control system 1 and a plurality of detection units (detectors) 2, The plurality of detection units 2 detect the user operation. The control system 1 reproduces a target sound in accordance with the operation detected by the detection unit 2. The target sound reproduced by the control system 1 is the performance sound of a musical instrument, such as a keyboard instrument. However, the sound of singing or speech can be reproduced as the target sound.

The control system 1 includes an electronic controller (control device 10), a storage device 11, and a sound output device 13. The control system 1 is realized, for example, by an information terminal, such as a smartphone, a tablet terminal, or a personal computer. The control system 1 can be realized as a single device or as a plurality of separate devices.

The electronic controller 10 is one or a plurality of processors that control each element of the control system 1. For example, the electronic controller 10 can be configured to comprise one or more types of processors, such as a CPU (Central Processing Unit), an SPU (Sound Processing Unit), a DSP (Digital Signal Processor), an FPGA (Field Programmable Gate Army), an ASIC (Application Specific integrated Circuit), etc. The electronic controller 10 generates an audio signal X representing the waveform of the target sound in accordance with the user operation. The term “electronic controller” as used herein refers to hardware that executes software programs.

The sound output device 13 reproduces the target sound represented by the audio signal X generated by the electronic controller 10. The sound output device 13 is a speaker or headphones, for example. The D/A converter that converts the audio signal X from digital to analog and the amplifier that amplifies audio signal X have been omitted from the figure for the sake of convenience. Further, the example shown in FIG. 1 shows a configuration in which the sound output device 13 is provided within the control system 1. In another example, the sound output device 13 can be separated from the control system 1 and connected to the control system 1 wirelessly or by wire.

The storage device 11 includes one or more memory units (computer memories) for storing a program to be executed by the electronic controller 10 and various data used by the electronic controller 10. The storage device 11 is a known storage medium, such as a magnetic storage medium or a semiconductor storage medium, or a combination of a plurality of various types of storage media. The storage device 11 can be separated from the control system 1 (for example, cloud storage), and the electronic controller 10 can read from or write to the storage device 11 via a communication network, such as a mobile communication network or the Internet. In other words, the storage device 11 can be omitted from the control system 1.

The reproduction control system 100 has a plurality of detection units 2 that correspond to different pitches (hereinafter referred to as “standard pitches”) Ps. Each of the plurality of detection units 2 is an operator with which the user issues an instruction to reproduce a target sound of standard pitch Ps corresponding to the detection unit 2. When the user operates the detection unit 2 out of the plurality of detection units 2 that corresponds to the desired standard pitch Ps, the target sound of the standard pitch Ps is reproduced. Each of the detection units 2 constitutes a key of a keyboard instrument, for example. In other words, the keyboard constitutes an array of the plurality of detection units 2, and the reproduction control system 100 is realized as a keyboard instrument.

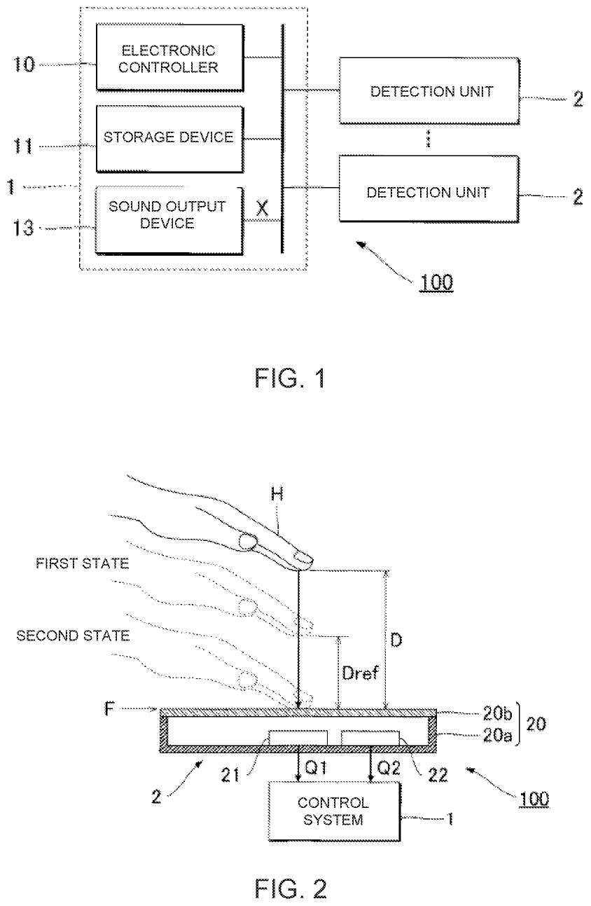

FIG. 2 is a schematic diagram illustrating the configuration of any one detection unit 2. The detection unit 2 has a housing 20, a first detector 21, and a second detector 22. The housing 20 of FIG. 2 is a hollow structure that houses the first detector 21 and the second detector 22. More specifically, the housing 20 has an enclosure portion 20a and a light transmission portion 20b. The enclosure portion 20a is a box-shaped structure that has an internal space and that is open at the top. The light transmission portion 20b is a plate-shaped member that closes the opening of the enclosure portion 20a. The light transmission portion 20b transmits light in a wavelength range that can be detected by the first detector 21. The light transmission portion 20b has an operation surface (striking surface) F, which is the surface opposite to the surface facing the enclosure portion 20a. The user can move his or her hand H close to or away from the operation surface F and can strike the operation surface F with his or her hand H. The user's hand H is one example of an “object.”

The first detector 21 is an optical sensor that detects the state of the user's hand H. The first detector 21 is installed in the vicinity of the midpoint (center) of the bottom surface of the enclosure portion 20a. Specifically, a distance-measuring sensor that measures the distance between the object and a light-receiving surface is used as the first detector 21. For example, the first detector 21 generates a time-series detection signal Q1 that represents the position of the hand (specifically, the distance from the light-receiving surface to hand H) in a direction perpendicular to the operation surface F by receiving the light reflected from the hand H that has passed through the light transmission portion 20b. The detection signal Q1 is transmitted to the control system 1 via wired or wireless communication. The light detected by the first detector 21 is not limited to visible light. For example, invisible light, such as infrared light, can be detected by the first detector 21.

The second detector 22 is a sensor for detecting the contact of the hand H with the operation surface F. For example, a sound collection device that collects ambient sounds is used as the second detector 22. The second detector 22 collects the striking sounds generated when the user's hand H strikes the operation surface F. The second detector 22 generates a detection signal Q2 that represents ambient sounds which include striking sounds. The detection signal Q2 is transmitted to the control system 1 via wired or wireless communication. The second detector 22 can be installed outside of the housing 20.

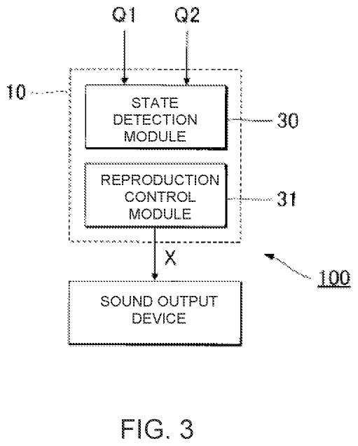

FIG. 3 is a block diagram illustrating the functional configuration of the control system 1. The electronic controller 10 of the control system 1 executes programs stored in the storage device 11 to realize a plurality of functions (state detection module (state detection unit) 30 and reproduction control module (reproduction control unit) 31).

The state detection module 30 detects the state of the user's hand H in accordance with the detection result (detection signal Q1 and detection signal Q2) of each of the plurality of detection units 2. More specifically, the state detection module 30 detects a first state or a second state as the state of the hand H. As shown in FIG. 2, in the first state, the hand H is separated from the operation surface F of one of the detection units 2 by a prescribed distance (hereinafter referred to as “reference value”) Dref. In the second state, the hand H is in contact with the operation surface F.

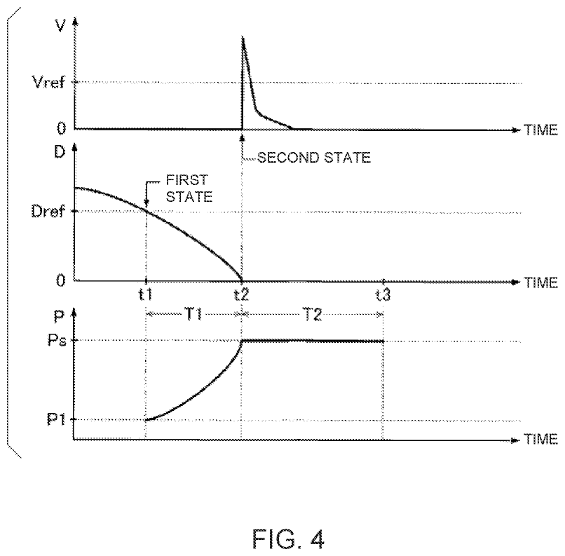

FIG. 4 is an explanatory diagram pertaining to the state of the hand H. The state detection module 30 analyzes the detection signal Q1 generated by the first detector 21 and detects that hand H is in the first state. More specifically, the state detection module 30 analyzes the detection signal Q1 and calculates a distance D between the operation surface F and the hand H. The calculation of the distance D is repeated at a prescribed cycle, That is, time-series data are generated that represent the distance D. Any known technology can be used to calculate the distance D. FIG. 4 illustrates temporal changes in distance D. The state detection module 30 determines that hand H is in the first state when the distance D between the operation surface F and the hand H matches a reference value Dref. The state detection module 30 can also determine that hand H is in the first state when the distance D is included in a prescribed allowable range that includes the reference value Dref. The reference value Dref is a preset fixed value. However, the reference value Dref can be changed in accordance with an instruction from the user.

The state detection module 30 also detects that hand H is in the second state by analyzing the detection signal Q2 generated by the second detector 22. More specifically, the state detection module 30 calculates a volume V of the sound represented by the detection signal Q2. The calculation of volume V is repeated at a prescribed cycle. That is, time-series data are generated that represent volume V. Any known technology can be used to calculate volume V. FIG. 4 illustrates temporal changes in volume V. When a striking sound is generated when the operation surface F is struck, there is an abrupt increase in volume V. When the volume V exceeds a prescribed value (hereinafter referred to as “reference value”) Vref (that is, when the striking sound is collected), the state detection module 30 determines that the hand H is in the second state. The reference value Vref is a preset fixed value. However, the reference value Vref can be changed in accordance with an instruction from the user.

The user can issue an instruction to reproduce the target sound of the desired standard pitch Ps by bringing his or her hand H close to the operation surface F of one detection unit 2 which corresponds to the desired standard pitch Ps, among the plurality of detection units 2. The user hand H sequentially enters the first state and the second state in a series of processes of approaching the operation surface F of one of the detection units 2. More specifically, the hand H is in the first state at a specific time point t1 (hereinafter referred to as “first time point”) during the process of the hand H approaching the operation surface F, and the hand H is in the second state at a time point t2 which is subsequent to first time point t1 (hereinafter referred to as “second time point”).

The first time point t1 and second time point t2 are separated by an interval on the time axis. FIG. 4 shows a time point t3 (hereinafter referred to as “third time point”) which is subsequent to second time point t2. Third time point t3 is the point in time after which a prescribed length of time has elapsed since second time point t2. Further, FIG. 4 shows a first time period T1 and a second time period 1′2, The first time period T1 is the period of time from the first time point t1 to the second time point t2, and the second time period T2 is the period of time from the second time point t2 to the third time point t3. The length of time of the first time period T (interval between first time point t1 and second time point t2) changes in accordance with the speed with which the user moves his or her hand H. The length of time of the second time period T2 (interval between the second time point t2 and the third time point t3) can be changed in accordance with an instruction from the user, for example.

The reproduction control module 31 of FIG. 3 causes the sound output device 13 to reproduce the target sound that corresponds to the detection unit 2 in accordance with the state of the hand H with respect to the operation surface F of each detection unit 2. The target sound of the standard pitch Ps that corresponds to the detection unit 2, out of the plurality of detection units 2, which the user's hand H approaches is reproduced. Specifically, the reproduction control module 31 generates the audio signal X that represents the target sound. For example, a plurality of waveform data representing the waveforms of the sounds of the plurality of different standard pitches Ps are stored in the storage device 11. The reproduction control module 31 reads from the storage device 11 the waveform data of standard pitch Ps that corresponds to the detection unit 2, out of the plurality of detection units 2, which the user's hand H approaches, processes the waveform data, and generates the audio signal X. The audio signal X is supplied to the sound output device 13, and the target sound is reproduced.

As illustrated in FIG. 4, in the case that user hand H approaches the operation surface F of any one of the plurality of detection units 2, the reproduction control module 31 generates the audio signal X so that target sound reproduction is initiated at the first time point t1 and is continued from the first time point t1 until the third time point t3, which is subsequent to second time point t2. In other words, the target sound continues from the first time point t1, before the hand H comes in contact with the operation surface F, to the third time point t3, after the contact.

The reproduction control module 31 temporally changes the pitch P of the target sound during the first time period T1 from the first time point t1 to the second time point t2. The reproduction control module 31 controls temporal changes in pitch P (that is, the trajectory of the change in pitch P with respect to the time axis) during the first time period T1. More specifically, the reproduction control module 31 linearly or curvilinearly changes the pitch P of the target sound during the first time period T1 from a first pitch P1 to the standard pitch Ps. The first pitch P1 is lower than standard pitch Ps by a prescribed value. Therefore, the first pitch P1 differs for each of the detection units 2. More specifically, the reproduction control module 31 changes the pitch P of the target sound during the entire first time period T1, so that pitch P of the target sound becomes the first pitch P1 at the first time point t1 and reaches the standard pitch Ps at second tune point t2. The change in pitch P during the first time period T1 corresponds to the pitch bend of the target sound. The pitch P is one example of a “feature amount” of the target sound. The standard pitch Ps is one example of a “target value.”

In order to realize the change in pitch P described above, the reproduction control module 31 changes the pitch P of the target sound at a rate (speed) corresponding to the movement speed with which the user hand H is moving (hereinafter referred to as “movement speed”) during the first time period T1. The movement speed is the amount of change in the distance D per unit time calculated by the state detection module 30. The state detection module 30 analyzes the detection signal (image signal) Q1 and calculates the movement speed. More specifically, the reproduction control module 31 changes the pitch P during the first time period of time T1 so that the rate of change in pitch P increases with the movement speed. By the configuration described above, the user can adjust the rate of change in pitch P during the first time period T1 in accordance with the movement speed of the hand H. In the first embodiment, the first pitch P1 and the standard pitch Ps are predetermined. The reproduction control module 31 controls the trajectory of the pitch P (rate of change) from the first pitch P1 to the standard pitch Ps during the first time period T1 in accordance with the movement speed of the user's hand H. A configuration can be employed in which the relationship between the rate of change in pitch P and the movement speed during the first time period T1 can be changed in accordance with an instruction from the user.

The reproduction control module 31 maintains the pitch P of the target sound at standard pitch Ps during the second time period T2 from the second time point t2 to the third time point t3. More specifically, the pitch P of the target sound is fixed to the standard pitch Ps throughout the second time period T2.

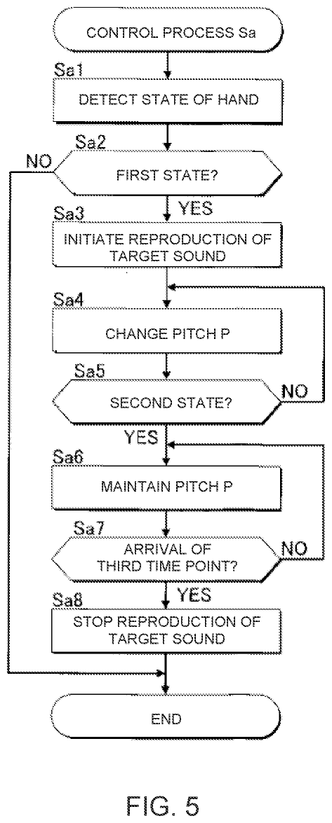

FIG. 5 is a flowchart illustrating the specific procedure of a process (hereinafter referred to as “control process”) Sa executed by the electronic controller 10. For example, the control process Sa is executed in parallel or sequentially for each of the plurality of detection units 2. The control process Sa is repeated in a cycle that is sufficiently shorter than the cycle in which the user's hand H approaches and separates from the operation surface F.

When the control process Sa is initiated, the state detection module 30 analyzes the detection signal Q1 and the detection signal Q2 supplied from the detection unit 2 to detect the state of the user's hand H (Sa1). The reproduction control module 31 determines whether the state detection module 30 has detected that the hand H is in the first state (Sa2). If the first state is detected (Sa2: YES), the reproduction control module 31 causes the sound output device 13 to initiate reproduction of the target sound of the first pitch P1 corresponding to the standard pitch Ps of the relevant detection unit 2 (Sa3). If the first state is not detected (Sa2: NO), the reproduction control module 31 ends the control process Sa.

When the reproduction of the target sound is initiated, the reproduction control module 31 changes the pitch P of the target sound in the direction of the standard pitch Ps (Sa4). More specifically, the electronic controller 10 brings the pitch P of the target sound closer to the standard pitch Ps by an amount of change that corresponds to the movement speed of the user's hand H. The reproduction control module 31 determines whether the state detection module 30 has detected that the hand H is in the second state (Sa5). If the second state is not detected (Sa5: NO), the reproduction control module 31 advances to the process of Step Sa4. In other words, during the first time period T1 until the second time point t2 when the second state is detected, the pitch P of the target sound temporally changes in the direction of the standard pitch Ps. By the process described above, the pitch P of the target sound reaches the standard pitch Ps at the second time point t2 when the second state is detected.

If the second state is detected (Sa5: YES), the reproduction control module 31 maintains the pitch P of the target sound at the standard pitch Ps (Sa6), The reproduction control module 31 determines whether the third time point t3 has arrived (Sa7). The pitch P of the target sound is maintained at the standard pitch Ps until the third time point t3 arrives (Sa7: No). In other words, the pitch P of the target sound is maintained at the standard pitch Ps during the second time period T2. When the third time point t3 arrives (Sa7: YES), the reproduction control module 31 stops reproduction of the target sound (Sa8).

As described above, in the first embodiment, target sound reproduction continues from the first time point t1, when the hand H is in the first state, until the third time point t3, which is subsequent to the second time point t2, when the hand is in the second state, and the pitch P of the target sound changes during the first time period T1, from the first time point t1 to the second time point t2. Therefore, it is possible for the user to change the pitch P of the target sound during the first time period T1 by a simple operation of bringing his or her hand H close to the operation surface F. In other words, it is possible to reduce the instructional burden of the user compared with a configuration that requires the user to issue separate instructions for reproducing the target sound and for changing the pitch P.

Further, in the first embodiment, since the pitch P of the target sound reaches the standard pitch Ps at the second time point t2 when the second state is entered, i.e., when the user's hand H comes in contact with the operation surface F, there is the advantage that the user can easily instruct the time that the pitch P reaches the standard pitch Ps. Further, because the pitch P of the target sound is maintained at the standard pitch Ps during the second time period T2, i.e., from the second time point t2 to the third time point t3, there is the advantage that the user can easily instruct the reproduction of the target sound at the standard pitch Ps.

### B: Second Embodiment

The second embodiment will be described below. In each of the following embodiments, elements that have functions that are similar to corresponding elements in the first embodiment have been assigned the same reference numerals that were used in the description in the first embodiment and their detailed descriptions have been appropriately omitted.

The reproduction control system 100 of the second embodiment detects a state (hereinafter referred to as “third state”) in which the hand H, which has come in contact with the operation surface F, begins to separate from the operation surface F. More specifically, the state detection module 30 detects, as the third state, the state in which the distance D between the operation surface F and the hand H starts to increase from zero.

In the first embodiment, the reproduction of the target sound is stopped at the third time point t3, which is the point in time after which a prescribed length of time has elapsed since the second time point t2. In the second embodiment, the reproduction of the target sound is stopped at the third time point t3, which is the point in time when the state detection module 30 detects the third state. In other words, reproduction of the target sound of the standard pitch Ps is continued during the period that user's hand H is in contact with operation surface F and is stopped when the user's hand H separates from the operation surface F.

The same effects as those of the first embodiment are realized in the second embodiment. Further, in the second embodiment, there is the advantage that the user can easily issue an instruction to stop the reproduction of the target sound by separating his or her hand H from operation surface F.

### C: Third Embodiment

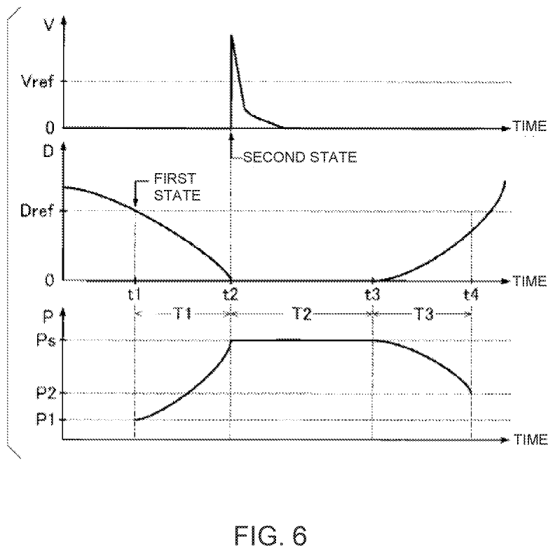

FIG. 6 is a diagram explaining the reproduction of the target sound in a third embodiment. The state detection module 30 of the third embodiment detects the third state in which the hand H separates from the operation surface F in the same manner as in the second embodiment.

FIG. 6 illustrates a time point (hereinafter referred to as “fourth time point”) t4 subsequent to the third time point t3 when the third state is detected. The fourth time point t4 is a point in time after which a prescribed length of time has elapsed since the third time point t3. The third time period T3 of FIG. 6 is the period of time from the third time point t3 to the fourth time point 14. The third period T3 corresponds to the process of the hand H separating from the operation surface F (process during which the distance D increases). The time length of the third time period T3 (interval between the third time point 13 and the fourth time point 14) can be changed in accordance with an instruction from the user, for example.

In addition to maintaining the pitch P of the target sound, the reproduction of which is initiated at the first time point t1, at the standard pitch Ps during the second time period T2, in the same manner as in the first embodiment, the reproduction control module 31 of the third embodiment temporally changes the pitch P of the target sound during the third time period T3. More specifically, the reproduction control module 31 linearly or curvilinearly changes the pitch P of the target sound during the third time period T3 from the standard pitch Ps to a second pitch P2. The second pitch P2 is lower than the standard pitch Ps by a prescribed value. Therefore, the second pitch P2 differs for each of the detection units 2. More specifically, the reproduction control module 31 temporally changes the pitch P of the target sound throughout the third time period T3, so that the pitch P of the target sound, which is at the standard pitch Ps at third time point t3, reaches the second pitch P2 at the fourth time point t4. Whether the first pitch P1 and the second pitch P2 are the same or different, as well as which pitch is higher (lower), can be arbitrarily set.

In order to realize the change in pitch P during the third time period T3 described above, the reproduction control module 31 changes the pitch P of the target sound at a rate (speed) that corresponds to the movement speed of the hand H during the third time period 13. More specifically, the reproduction control module 31 changes the pitch P during the third time period T3 such that the rate of change in pitch P increases with the movement speed. By the configuration described above, the user can adjust the rate of change in pitch P during the third time period T3 in accordance with the movement speed of the hand H. The relationship between the rate of change in pitch P and the movement speed during the third time period T3 can be changed in accordance with an instruction from the user.

### D: Modification

Specific modified embodiments to be added to each of the aforementioned embodiment examples are illustrated below. Two or more embodiments arbitrarily selected from the following examples can be appropriately combined insofar as they are not mutually contradictory.

(1) In the embodiments described above, cases in which the first detector 21 is a distance measurement sensor is used as an example, but the type of first detector 21 is not limited to the example described above. For example, an image sensor that captures an image of the user's hand H can be used as the first detector 21. In this case, the state detection module 30 analyzes the image of the hand. H captured by the first detector 21 to calculate the distance D, and detects the first state in accordance with the distance D. Further, an infrared sensor that emits and receives infrared light can be used as the first detector 21. In this case, the state detection module 30 calculates the distance D from the intensity of the received infrared light reflected from the surface of the hand H. Further, the position in which the first detector 21 is installed is arbitrary. For example, the first detector 21 can capture an image of the hand H from the side.

(2) In the aforementioned embodiments, the detection signal Q2 that represents sounds that include striking sounds is analyzed to detect the second state, but the configuration and method of detecting the contact of the hand H with the operation surface F is not limited to the example described above. For example, the detection signal Q1 generated by the first detector 21 can be analyzed to detect contact of the hand H with the operation surface F (that is, the second state). For example, the state detection module 30 determines that the user's hand H is in the second state when distance D identified from the detection signal Q1 reaches zero. The second detector 22 is omitted in a configuration in which detection signal Q1 is used for the detection of the second state. Further, a contact sensor (for example, an electrostatic capacitive sensor) that detects contact of the hand H with the operation surface F (light transmission portion 20b), a vibration sensor that detects the vibration of the operation surface F (light transmission portion 20b), or a pressure sensor that detects pressure from the hand H that acts on the operation surface F can be used as the second detector 22.

(3) In the aforementioned embodiments, a configuration in which the user's hand H comes in contact with the operation surface F is used, but the object coming in contact with the operation surface F is not limited to a hand H. For example, the user can strike operation surface F with a striking member such as a stick for a percussion instrument. As can be understood from the examples described above, objects coming in contact with the operation surface F include both a part of the user's body (typically, hand H) and a striking member operated by the user. In a configuration in which a striking member strikes the operation surface F, the first detector 21 or the second detector 22 can be mounted on the striking member.

(4) The configuration of the housing 20 of the detection unit 2 is arbitrary. Further, the structure in which the first detector 21 and the second detector 22 are housed in the housing 20 is not mandatory. In other words, as long as the detection unit 2 includes the operation surface F with which an object such as the user's hand H comes in contact, the specific structure and presence/absence of the housing 20 are not particularly limited.

(5) In the aforementioned embodiments, the pitch P of the target sound is changed throughout the first time period T1, but the pitch P of the target sound can be changed during a part of the first time period T1, and the pitch P can be maintained during the remaining period. In other words, the pitch P of the target sound can reach the standard pitch Ps before the arrival of second time point t2. As can be understood from the foregoing explanation, the “change in pitch P during the first time period T1” means a change in pitch P during some or all of the first time period T1. Similarly, a “change in pitch P during the third time period T3” means a change in pitch P during some or all of third time period T3.

(6) In the aforementioned embodiments, the pitch P of the target sound is changed at a rate corresponding to the movement speed of the user's hand H, but the way in which the pitch P is linked to the movement speed of the user's hand H is not limited to the examples described above. For example, the pitch P of the target sound can be changed in accordance with the distance D of the hand H with respect to the operation surface F. The reproduction control module 31 can, for example, temporally changes the pitch P of the target sound so that the pitch P increases as the distance D decreases, with the pitch P reaching the standard pitch Ps when the distance D becomes zero. During the first time period T1, the pitch P can be decreased as the distance D increases.

Further, the reproduction control module 31 can change the pitch P of the target sound in accordance with the direction in which the user's hand H moves (hereinafter referred to as “direction of movement). The state detection module 30 analyzes the detection signal (image signal) Q1 to identify the direction of movement of the hand H with respect to the operation surface F. The reproduction control module 31 controls the relationship between changes in pitch P with respect to the time axis (that is, the trajectory of pitch P with respect to the passage of time) in accordance with the direction of movement of hand H. More specifically, when the angle of the direction of movement with respect to the operation surface F is within a first range, the reproduction control module 31 changes the pitch P to follow a first trajectory over time. On the other hand, when the angle of the direction of movement with respect to the operation surface F is within a second range, the reproduction control module 31 changes the pitch P to follow a second trajectory, which is different from the first trajectory, over time. For example, when the angle between the direction of movement and the operation surface F exceeds a prescribed threshold value, the reproduction control module 31 changes the pitch P abruptly with respect to time (first trajectory). On the other hand, when the angle between the direction of movement and the operation surface F is less than the threshold value, the reproduction control module 31 changes pitch P gradually with respect to time (second trajectory).

As can be understood from the example described above, the reproduction control module 31 changes the pitch P of the target sound in accordance with a parameter related to the position of user hand H. The above-mentioned movement speed, distance D, and direction of movement are specific examples of parameters related to the position of the hand H. The position of the user's hand H itself can also be used as a parameter. For example, in addition to the position of the hand H a direction perpendicular to the operation surface F (for example, the distance D), the position of hand H in a plane parallel to operation surface F is included in the parameters related to the position of the hand H. The parameters related to the position of the hand H are identified by analysis of the detection signal (image signal) Q1, for example, as illustrated in the aforementioned embodiments.

(7) In the aforementioned embodiments, a configuration in which the first pitch P1 is lower than the standard pitch Ps is described, but a configuration in which the first pitch P1 is higher than the standard pitch Ps can also be used. In other words, the pitch P of the target sound can decrease with time from the first pitch P1 to the standard pitch Ps during the first time period T1. Further, the first pitch P1 can be set in accordance with an instruction from the user.

In the third embodiment, a configuration in which the second pitch P2 is lower than the standard pitch Ps is described, but a configuration in which the second pitch P2 is higher than the standard pitch Ps can also be used. In other words, the pitch P of the target sound can increase with time from the second pitch P2 to the standard pitch Ps during the third time period T3. Further, the second pitch P2 can be set in accordance with an instruction from the user.

(8) In the aforementioned embodiments, the pitch P of the target sound is controlled in accordance with the state of the hand H, but the feature amount of the target sound to be controlled by the reproduction control module 31 is not limited to the pitch P. For example, the volume of the target sound can be controlled in accordance with the state of the hand H. Further, the tone of the target sound can be controlled in accordance with the state of the hand H. For example, the reproduction control module 31 generates an audio signal X representing the target sound of an intermediate tone between a first tone and a second tone by mixing first waveform data representing the sound of the first tone and second waveform data representing the sound of the second tone. The reproduction control module 31 changes the mixing ratio of the first waveform data and the second waveform data in accordance with the state of the user's hand H, in the same manner as with the pitch P in the aforementioned embodiments. By the configuration described above, it is possible bring the tone of the target sound from one of the first tone and the second tone to the other during the first time period T1 or the third time period T3, for example.

(9) in the aforementioned embodiments, a configuration in which the user's hand H actually comes in contact with the operation surface F is used as an example, but a configuration can be adopted in which the user touches a virtual operation surface F using haptic technology (haptics) that employs tactile feedback, for example. In this case, the user operates a simulated hand that exists in virtual space to contact the operation surface F installed in the virtual space. By using a vibrating body that vibrates when the operation surface F in virtual space is touched, the user perceives that he or she is actually in contact with the operation surface F. As can be understood from the foregoing explanation, the operation surface F can be a virtual surface in virtual space. Similarly, the object (e.g., hand H) that comes in contact with operation surface F can be a virtual object in virtual space.

(10) As described above, the functions of the reproduction control system 100 (particularly the function of the control system 1) used by way of example above are realized by cooperation between one or a plurality of processors that constitute the electronic controller 10 and a program stored in the storage device 11. The program according to the present disclosure can be provided in a form stored in a computer-readable storage medium and installed in a computer. For example, the storage medium can be a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. Further, in a configuration in which a distribution device distributes the program via a communication network, a storage device that stores the program in the distribution device corresponds to the non-transitory storage medium.

### E: Additional Statement

For example, the following configurations can be understood from the foregoing embodiment examples.

A reproduction control method according to one aspect (Aspect 1) of the present disclosure is executed by a computer and comprises detecting a first state in which an object is separated from an operation surface by a prescribed distance and a second state in which the object is in contact with the operation surface, initiating sound reproduction at a first time point when the first state is detected, continuing the sound reproduction from the first time point to a third time point, which is subsequent to a second time point when the second state is detected, and controlling a change in a feature amount of the sound within a first time period, i.e., from the first time point to the second time point.

By the aspect described above, sound reproduction is maintained from the first time point, when the object is in the first state, until the third time point, which is subsequent to the second time point, when the object is in the second state, and the feature amount of the sound is varied during the first time period from the first time point to the second time point. Therefore, it is possible to reduce the user burden compared with a configuration that requires the user to issue separate instructions for reproducing the target sound and for changing the feature amount. The feature amount of the sound can be, for example, the pitch, volume, or timbre.

In a specific example (Aspect 2) of Aspect 1, the control includes changing a feature amount of the sound during the first time period such that the feature amount of the sound reaches a target value at the second time point. By the aspect described above, since the feature amount of the sound reaches the target value at the second time point when the second state is entered when the object comes in contact with the operation surface, there is the advantage that the user can easily control the time that the feature amount reaches the target value.

In a specific example (Aspect 3) of Aspect 2, the reproduction control method further comprises maintaining the feature amount of the sound at the target value during a second time period, i.e., from the second time point to the third time point, By this aspect, because the feature amount of the sound is maintained at the target value during the second time period, i.e., from the second time point to the third time point, there is the advantage that the user can easily instruct the reproduction of the sound whose feature amount is the target value.

In a specific example (Aspect 4) of any one of Aspects 1 to 3, the control includes changing the feature amount of the sound in accordance with a parameter related to the position of the object during the first time period. By this aspect, the trajectory of the change in the feature amount can be adjusted during the first time period in accordance with the position of the object. Examples of parameters related to the position of the object include the speed with which the object Moves (Aspect 5), the distance of the object with respect to the operation surface (Aspect 6), and the direction of movement of the object (Aspect 7).

In a specific example (Aspect 8) of any one of Aspects 1 to 7, the feature amount of the sound is the pitch of the sound. By the configuration described above, the change in pitch (pitch bend) can be controlled at the beginning (during the first time period) of the start of sound reproduction.

A reproduction control method according to one aspect (Aspect 9) of this disclosure is executed by a computer and comprises reproducing sound in a state in which an object is in contact with an operation surface, and changing a feature amount of the sound at a rate that corresponds to the speed with which the object is moving in the process of the object separating from the operation surface.

A reproduction control system according to one aspect (Aspect 10) of this disclosure comprises a state detection unit for detecting a first state in which an object is separated from an operation surface by a prescribed distance and a second state in which the object is in contact with the operation surface, and a reproduction control unit for initiating sound reproduction at a first time point when the first state is detected, continuing sound reproduction from the first time point to a third time point, which is subsequent to a second time point when the second state is detected, and controlling a change in a feature amount of the sound within a first time period, i.e., from the first time point to the second time point.

A program according to one aspect (Aspect 11) of this disclosure causes a computer to execute a process for detecting a first state in which an object is separated from an operation surface by a prescribed distance and a second state in which the object is in contact with the operation surface, initiating sound reproduction at a first time point when the first state is detected, continuing sound reproduction from the first time point to a third time point, which is subsequent to a second time point when the second state is detected, and controlling a change in a feature amount of the sound within a first time period, i.e., from the first time point to the second time point.

The present disclosure can be applied to a reproduction control method, a reproduction control system, or a program. The reproduction control method is executed by the electronic controller 10 as a computer.

What is claimed is:

1. A reproduction control method executed by a computer, the reproduction control method comprising:
detecting a first state in which an object is separated from an operation surface by a prescribed distance and a second state in which the object is in contact with the operation surface;
initiating sound reproduction at a first time point at which the first state is detected;
continuing the sound reproduction from the first time point to a third time point which is subsequent to a second time point at which the second state is detected; and
controlling a change in a feature amount of a sound during a first time period from the first time point to the second time point.

2. The reproduction control method according to claim 1, wherein
the controlling includes changing the feature amount of the sound during the first time period such that the feature amount of the sound reaches a target value at the second time point.

3. The reproduction control method according to claim 2, further comprising
maintaining the feature amount of the sound at the target value during a second time period from the second time point to the third time point.

4. The reproduction control method according to claim 1, wherein
the controlling includes changing the feature amount of the sound in accordance with a parameter related to a position of the object during the first time period.

5. The reproduction control method according to claim 4, wherein
the parameter is a speed with which the object moves.

6. The reproduction control method according to claim 4, wherein
the parameter is a distance of the object from the operation surface.

7. The reproduction control method according to claim 4, wherein
the parameter is a direction of movement of the object.

8. The reproduction control method according to claim 1, wherein
the feature amount of the sound is a pitch of the sound.

9. A reproduction control method executed by a computer, the reproduction control method comprising:
reproducing a sound in a state in which an object is in contact with an operation surface; and
changing a feature amount of the sound with a speed that corresponds to a movement speed with which the object is moving in a process of the object separating from the operation surface.

10. A reproduction control system comprising:
an electronic controller including at least one processor,
the electronic controller being configured to execute a plurality of modules including
a state detection module configured to detect a first state in which an object is separated from an operation surface by a prescribed distance and a second state in which the object is in contact with the operation surface, and
a reproduction control module configured to initiate sound reproduction at a first time point at which the first state is detected, continue the sound reproduction from the first time point to a third time point which is subsequent to a second time point at which the second state is detected, and control a change in a feature amount of a sound during a first time period from the first time point to the second time point.

11. The reproduction control system according to claim 10, wherein
the reproduction control module is configured to change the feature amount of the sound during the first time period such that the feature amount of the sound reaches a target value at the second time point.

12. The reproduction control system according to claim 11, wherein
the reproduction control module is further configured to maintain the feature amount of the sound at the target value during a second time period from the second time point to the third time point.

13. The reproduction control system according to claim 10, wherein
the reproduction control module is configured to change the feature amount of the sound in accordance with a parameter related to a position of the object during the first time period.

14. The reproduction control system according to claim 13, wherein
the parameter is a speed with which the object moves.

15. The reproduction control system according to claim 13, wherein
the parameter is a distance of the object from the operation surface.

16. The reproduction control system according to claim 13, wherein
the parameter is a direction of movement of the object.

17. The reproduction control system according to claim 10, wherein
the feature amount of the sound is a pitch of the sound.

18. A non-transitory computer readable medium storing a program that causes a computer to execute a process, the process comprising:
detecting a first state in which an object is separated from an operation surface by a prescribed distance and a second state in which the object is in contact with the operation surface;
initiating sound reproduction at a first time point at which the first state is detected,
continuing the sound reproduction from the first time point to a third time point which is subsequent to a second time point at which the second state is detected; and
controlling a change in a feature amount of a sound during a first time period from the first time point to the second time point.

19. The non-transitory computer readable medium according to claim 18, wherein
the controlling includes changing the feature amount of the sound during the first time period such that the feature amount of the sound reaches a target value at the second time point.

20. The non-transitory computer readable medium according to claim 19, wherein
the process further comprises maintaining the feature amount of the sound at the target value during a second time period from the second time point to the third time point.
